(19) United States
(12) Patent Application Publication
(10) Pub. No.: US 2026/0146166 A1
(43) Pub. Date: May 28, 2026

(54) OXIDATION RESISTANT COATINGS AND SURFACE-MODIFIED METAL MATERIAL

(71) Applicant: Industrial Technology Research Institute, Hsinchu (TW)

(72) Inventors: Li-Shing Chou, Tainan City (TW); Chien-Hsien Cheng, Tainan City (TW); Ming-Hsueh Chiang, New Taipei City (TW); Chi-San Chen, Kaohsiung City (TW)

(73) Assignee: Industrial Technology Research Institute, Hsinchu (TW)

(21) Appl. No.: 19/073,059

(22) Filed: Mar. 7, 2025

(30) Foreign Application Priority Data
Nov. 27, 2024 (TW) 113145801

(51) Int. Cl. C09D 5/08; C09D 165/04; C22C 33/04; C22C 38/00

(52) U.S. Cl. CPC C09D 5/086; C09D 165/04; C22C 38/002; C22C 38/005; C22C 33/04

(57) ABSTRACT

An oxidation resistant coating includes a chloro-substituted parylene, a fluorine-substituted parylene, and an alkyl-substituted parylene. A weight ratio of chlorine to fluorine to an alkyl group in the oxidation resistant coating is 1-10:6-27:2-15. The oxidation resistant coating is utilized to coat the surfaces of a metallic body made of a readily oxidizable material for forming a surface-modified metal material.

### CROSS-REFERENCE TO RELATED APPLICATION

This application claims the priority benefit of Taiwan application serial no. 113145801, filed on Nov. 27, 2024. The entirety of the above-mentioned patent application is hereby incorporated by reference herein and made a part of this specification.

### TECHNICAL FIELD

The disclosure relates to an oxidation resistant coating and a surface-modified metal material having the oxidation resistant coating.

### BACKGROUND

Most metal materials have high surface activity. In an environment with high temperature, warm humidity, electrochemical conditions, or oxygen, surfaces of the metal materials adsorb oxygen and moisture easily, leading to oxidation and corrosion on surfaces of the metal materials, which may result in certain performance degradation. For example, surface oxidation of a neodymium iron boron material may cause a decrease in magnetic performance. Therefore, the neodymium iron boron material requires vacuum or inert atmosphere protection throughout the entire preparation process, and must be coated with an oxidation resistant coating immediately after preparation to avoid surface oxidation. Currently, the common method is to form Al, Zn, Ni, Cu, or alloy coatings thereof on the surface of the metal material, so that the metal material may not be readily oxidizable during the storage process after preparation, which ensures performances remained.

Because the metal material needs to be subsequently processed or formed, it is necessary to use high temperature to remove the coating layer. However, if the aforementioned oxidation resistant coating has residues during the high-temperature sintering process, the processing applications of the metal material may be limited.

### SUMMARY

According to embodiments of the disclosure, an oxidation resistant coating is provided. The oxidation resistant coating includes a chloro-substituted parylene, a fluorine-substituted parylene, and an alkyl-substituted parylene. A weight ratio of the chlorine to the fluorine to the alkyl group in the oxidation resistant coating is 1-10:6-27:2-15.

According to embodiments of the disclosure, a surface-modified metal material is provided. The surface-modified metal material includes a metallic body and a coating layer coated on the surfaces of the metallic body. The coating layer is the aforementioned oxidation resistant coating.

To make the aforementioned features of the disclosure comprehensible, embodiments in conjunction with the accompanying drawings are described as follows.

### BRIEF DESCRIPTION OF THE DRAWINGS

FIG. 1 is a scanning electron microscope (SEM) image of a surface modified neodymium iron boron alloy powder of Experimental Example 2.

FIG. 2 is a thermogravimetric analysis (TGA) curve of a freshly produced neodymium iron boron alloy powder without surface modification.

FIG. 3 is a differential thermal analysis (DTA) curve of a surface modified neodymium iron boron alloy powder of Experimental Example 4.

### DETAILED DESCRIPTION OF DISCLOSED EMBODIMENTS

The following content provides different embodiments for realizing various features of the disclosure. However, these embodiments are only for demonstration and are not intended to limit the scope and application of the disclosure.

According to embodiments of the disclosure, an oxidation resistant coating is provided. The oxidation resistant coating includes: a chloro-substituted parylene, a fluorine-substituted parylene, and an alkyl-substituted parylene.

A weight ratio of the chlorine to the fluorine to the alkyl group in the oxidation resistant coating is 1-10:6-27:2-15. In some embodiments, a weight ratio of the chlorine to the fluorine to the alkyl group in the oxidation resistant coating is 1-8:6-25:2-10. In some embodiments, a weight ratio of the chlorine to the fluorine to the alkyl group in the oxidation resistant coating is 1-8:8-25:4-10.

In some embodiments, the alkyl group in the aforementioned alkyl-substituted parylene may be a C1-C6 straight chain or branched chain alkyl, such as methyl, ethyl, propyl, butyl, pentyl, hexyl, isopropyl, isobutyl, sec-butyl, tert-butyl, isopentyl, 2-methylbutyl, 1-methylbutyl, 1-ethylpropyl, 1,2-dimethylpropyl, neopentyl, 1,1-dimethylpropyl, 4-methylpentyl, 3-methylpentyl, 2-methylpentyl, 1-methylpentyl, 2-ethylbutyl, 1-ethylbutyl, 3,3-dimethylbutyl, 2,2-dimethylbutyl, 1,1-dimethylbutyl, 2,3-dimethylbutyl, 1,3-dimethylbutyl or 1,2-dimethylbutyl, or isomers thereof.

According to an embodiment of the disclosure, based on 100 parts by weight of a total weight of the oxidation resistant coating, the chloro-substituted parylene accounts for 5 to 40 parts by weight, the fluorine-substituted parylene accounts for 20 to 80 parts by weight, and the alkyl-substituted parylene accounts for 10 to 40 parts by weight.

In some embodiments, the chloro-substituted parylene may be

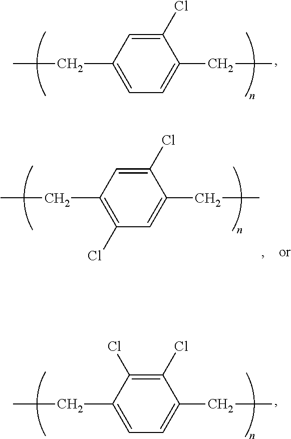

where n is an integer between 100 to 10000.

In some embodiments, the fluorine-substituted parylene may be

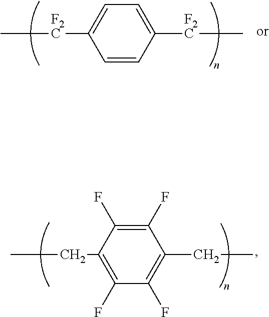

where n is an integer between 100 to 10000.

In some embodiments, the alkyl-substituted parylene may be

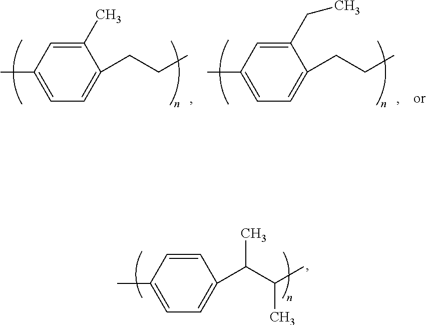

where n is an integer between 100 to 10000.

According to embodiments of the disclosure, a surface-modified metal material is provided. The surface-modified metal material includes a metallic body and a coating layer. The coating layer is coated on the surfaces of the metallic body to prevent the metallic body from being oxidized. The coating layer is the aforementioned oxidation resistant coating. In some embodiments, entire surfaces of the metallic body may be coated by the coating layer for further to avoid surface oxidation of the metallic body.

In some embodiments, a material of the metallic body may be a readily oxidizable material. The readily oxidizable material includes, for example, an iron-containing material, an aluminium-containing material, a cobalt-containing material, a nickel-containing material, or a copper-containing material, etc. The iron-containing material includes, for example, neodymium-iron-boron (NdFeB) or samarium-iron-nitride. The nickel-containing material includes, for example, aluminium-nickel-cobalt (alnico), etc. The material of the metallic body may be a pure metal or an alloy.

In some embodiments, a weight ratio of the metallic body to the coating layer may be 9-19, for example 10-17 or 10-15.

In some embodiments, the metallic body may be a powder, and a particle size of the powder may be between 1 μm and 80 μm, for example between 1 μm and 50 μm or between 1 μm and 20 μm. The metallic powder generally presents in an irregular shape or tends to be flaky; therefore, a “particle size” in the disclosure refers to a median diameter. The median diameter is a particle diameter at 50% height (also known as D50 value) in a cumulative distribution curve (number-based) of particle size. When the particle size of the powder is smaller, a thickness of the coating layer tends to be thinner to avoid interference from excessive impurities in subsequent processing. In some embodiments, if the surface-modified metal material is a neodymium-iron-boron powder, the particle size of the obtained surface modified neodymium-iron-boron material may be between 2 μm and 80 μm, for example between 2 μm and 50 μm or between 2 μm and 20 μm. The thickness of the coating layer may be, for example, between 0.2 μm and 1.2 μm.

In other embodiments, the metallic body may be a bulk material. The bulk material may be, for example, a bulk material formed by pressing the metallic powders into a block and sintering, and the bulk material may have various shapes and sizes according to design requirements.

Based on the above, the surface-modified metal material of the disclosure is made from the metallic body coated by parylene polymers, which effectively achieves an oxidation resistant effect, and also achieves an effect of no polymer residue during high-temperature sintering according to a low boiling point characteristic of the aforementioned polymers.

Several experiments are listed as follows to verify efficacy of the disclosure, but these experiments and results thereof are not intended to limit the scope of application of the disclosure.

Raw materials of metallic body:
1. Pure neodymium, pure iron, and ferroboron (with a weight ratio of neodymium, iron, and boron of approximately 30:69:1) were placed in a melting crucible and melted into liquid by vacuum induction melting. The neodymium-iron-boron melt was rapidly solidified into a thin sheet by a strip casting method. The thin sheet was then subjected to a hydrogen absorption process and an air flow grinding process to obtain neodymium-iron-boron alloy powders. The neodymium-iron-boron alloy powders are used as the metallic body. A particle size D50 of the obtained neodymium-iron-boron alloy powders is approximately 2 to 10 μm.
2. Maximum magnetic energy product analysis of non-oxidized neodymium-iron-boron alloy powders: The freshly produced neodymium-iron-boron alloy powders were immediately formed into a circular bulk material with a diameter of 8 to 10 mm and a thickness of about 5 mm, and then subjected to the subsequent maximum magnetic energy product analysis, which is 350 kJ/m³. In other words, a maximum magnetic energy product of the freshly produced neodymium-iron-boron alloy powders without surface modification is 350 kJ/m³.
3. Maximum magnetic energy product analysis of accelerated oxidized neodymium-iron-boron alloy powders: The freshly produced neodymium-iron-boron alloy powders were placed in a constant temperature and constant humidity environment (temperature of 85° C./humidity of 85%) for 120 hours before being formed into a bulk material, and then subjected to the subsequent maximum magnetic energy product analysis, resulting in a maximum magnetic energy product of 203 kJ/m³. Therefore, from the previous analysis, the neodymium-iron-boron powders without surface modification may have a high degree of surface oxidation and corrosion after experiencing a constant temperature and constant humidity environment, affecting the magnetic property of the bulk material, with a maximum magnetic energy product loss rate of −42% (=(203−350)/350×100%).

Oxidation resistant coating raw material for the coating layer:
1. Raw material for chloro-substituted parylene: Parylene C dimer (purchased from Jingming Chemical, with a product name dichloro-p-cyclophane).
2. Raw material for fluorine-substituted parylene: Parylene F dimer (purchased from Jingming Chemical, with a product name α-Perfluorodi-p-xylene).
3. Raw material for alkyl-substituted parylene: Parylene AM-2 dimer (purchased from Jingming Chemical, with a product name α, α′-dimethoxy-p-xylene).

### Experimental Examples 1 to 6 Preparation of Surface-Modified Neodymium-Iron-Boron Alloy Material by Using Chemical Vapor Deposition Film Formation

First, the chemical vapor deposition film formation process involved placing the oxidation resistant coating raw material in an evaporation chamber, where amounts of the coating material used in Experimental Examples 1 to 6 are shown in Table 1 below. Next, the freshly produced neodymium-iron-boron alloy powders were placed in the deposition chamber, and the entire reaction apparatus was evacuated under vacuum. Subsequently, the furnace temperature was controlled at 680-700° C., and the vapor chamber was heated to 150° C., so that the oxidation resistant coating raw material was first evaporated into gas and sent to the pyrolysis furnace to decompose into monomers, which were then sent to the deposition chamber at room temperature. The monomers polymerized and deposited on surfaces of the neodymium-iron-boron alloy powders, obtaining the surface-modified neodymium-iron-boron alloy material of Experimental Examples 1 to 6. The chemical vapor deposition film formation process took approximately 1 hour.

### Comparative Examples 1 to 3

The same preparation method as the aforementioned Experimental Examples was adopted, but the oxidation resistant coating raw material was changed to a single component from Table 2 for preparation, obtaining the surface-modified neodymium-iron-boron materials of Comparative Examples 1 to 3.

### Comparative Examples 4 to 14

The same preparation method as the aforementioned Experimental Examples was adopted, but the oxidation resistant coating raw material was changed to the components and amounts shown in Table 3 for preparation, obtaining the surface-modified neodymium-iron-boron materials of Comparative Examples 4 to 14.

[symbol]

Analysis Method

[symbol]

### 1. Thickness

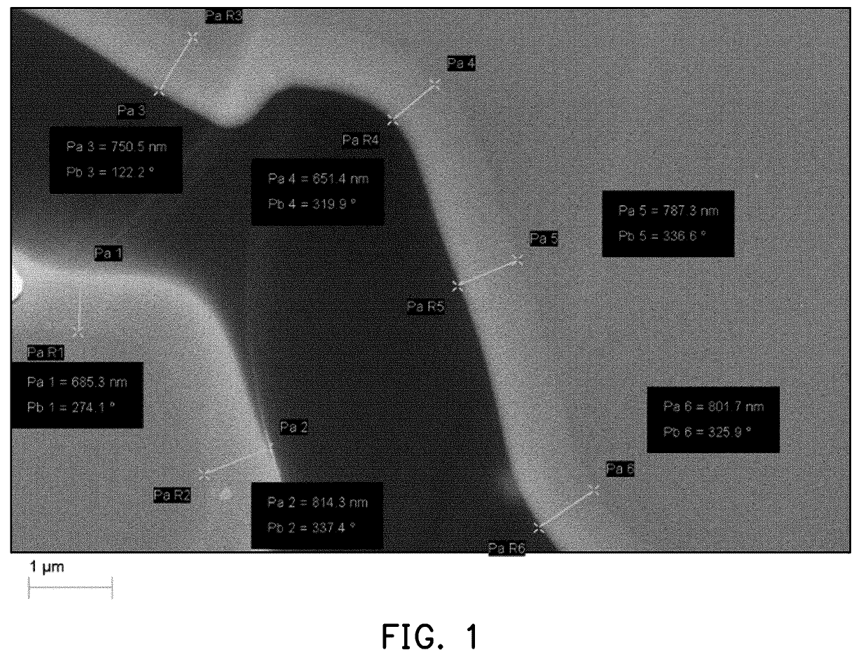

The particle size D50 of the final product was obtained by using SEM (JEOL JSM-6330TF) image analysis method. For example, FIG. 1 shows the SEM image of the surface-modified neodymium-iron-boron material of Experimental Example 2, where the neodymium-iron-boron (NdFeB) alloy powder presents in an irregular shape, and a thickness of the oxidation resistant coating layer on surfaces of the NdFEB powder is generally uniform, with a thickness distribution between 814.3 nm and 651.4 nm. The measured thickness D50 of the oxidation resistant coating of Experimental Example 2 is 0.74 μm.

### 2. Decomposition Temperature

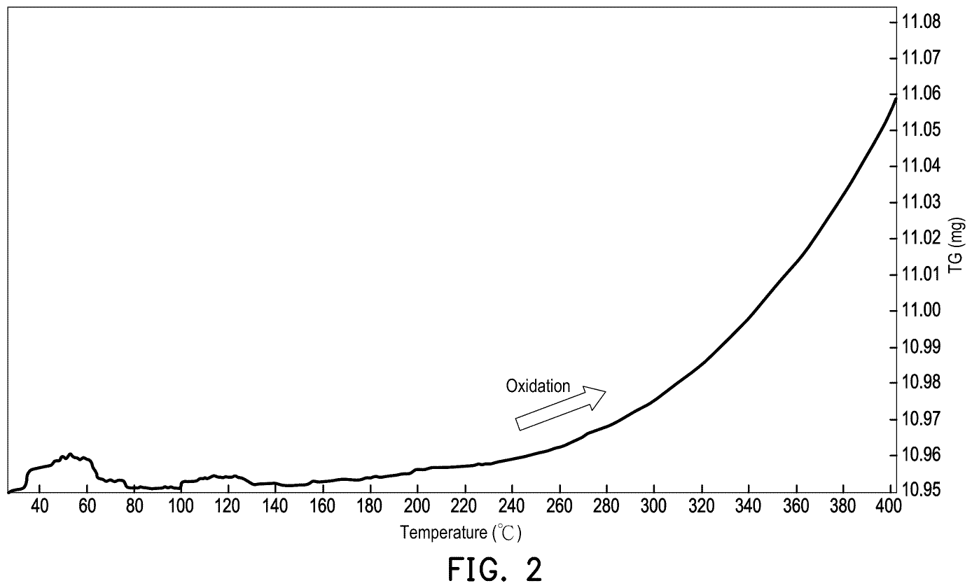

The measurement was conducted by using a thermogravimetric analyser (Mettler Toledo TGA 2). A sample was placed in a programmable heating furnace capable of controlling temperature increase and decrease, with air flowing through. The sample was heated from room temperature to 400° C., and a weight change of the sample was recorded as a function of temperature and time. For example, FIG. 2 shows the TGA curve of the freshly produced neodymium-iron-boron alloy powders without oxidation resistant coating. From FIG. 2, a weight of a sample of the freshly produced neodymium-iron-boron alloy powders without oxidation resistant coating increases throughout the entire testing process, indicating that the neodymium-iron-boron powders without oxidation resistant coating protection is easily oxidized, resulting in weight increase with temperature.

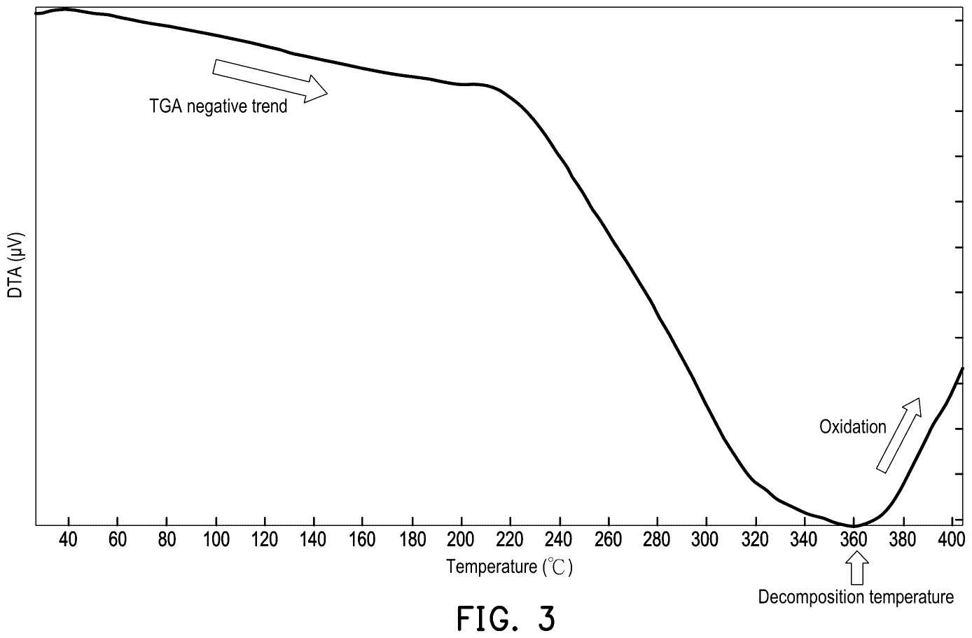

The thermogravimetric analyzer was also utilized to measure the DTA curve, and the decomposition temperature of the coating layer in the sample may be obtained through the changes in the DTA curve. For example, FIG. 3 shows the DTA change of the surface-modified neodymium-iron-boron composite material of Experimental Example 4, where there is an obvious endothermic peak at 360° C., indicating that the coating layer of Experimental Example 4 undergoes pyrolysis (decomposition) at this temperature. Subsequently, due to the oxidation of neodymium-iron-boron, the DTA curve rises again.

### 3. Constant Temperature and Constant Humidity Test

The sample was placed in an environment with a temperature of 85° C. and humidity of 85% for 120 hours.

### 4. Maximum Magnetic Energy Product

The samples (powders) that underwent the aforementioned constant temperature and constant humidity test were made into circular bulk materials with a diameter of 8 to 10 mm and a thickness of about 5 mm. According to the IEC 60404-5 magnetic test method for permanent magnetic (hard magnetic) materials, a Vibrating Sample Magnetometer (VSM) was utilized to measure and examine the hysteresis curve of the aforementioned bulk materials.

The VSM chamber contains an electromagnet with a fixed direction, with a magnetic field strength ranging from 0 to 3 T, a temperature ranging from 50 K to 400 K, and a magnetic field resolution of 106 emu. When vibrating within the chamber, the bulk material exhibits different magnetization intensities under different magnetic fields. By measuring a degree of magnetic flux change through induction coils and converting the magnetization intensity to induced voltage, the magnetic moment of the bulk material may be tested. Further dividing by the volume of the bulk material, the maximum magnetic energy product may be obtained.

The results obtained from the aforementioned analysis for all Experimental Examples and Comparative Examples are listed in the following Table 1 to Table 3.

TABLE 1

| | | | | | | Constant | Maximum |
|---|---|---|---|---|---|---|---|
| | Oxidation resistant | | | Thickness | | temperature | magnetic |
| | coating raw material | | | of the | Decomposition | and humidity | energy |
| Experimental | (parts by weight) | | | coating | temperature | test time | product |
| Example | C | AM2 | F | layer (μm) | (° C.) | (hr) | (kJ/m³) |
| 1 | 40 | 40 | 20 | 1.12 | 320 | 120 | 330 |
| 2 | 30 | 30 | 40 | 0.74 | 340 | 120 | 336 |
| 3 | 25 | 25 | 50 | 0.21 | 320 | 120 | 342 |
| 4 | 20 | 20 | 60 | 0.29 | 360 | 120 | 325 |
| 5 | 10 | 10 | 80 | 0.28 | 380 | 120 | 318 |
| 6 | 5 | 15 | 80 | 0.33 | 350 | 120 | 307 |

In Table 1, C represents the Parylene C raw material dichloro-p-cyclophane, AM2 represents the Parylene AM-2 raw material α, α′-dimethoxy-p-xylene, and F represents the Parylene F raw material α-Perfluorodi-p-xylene.

From Table 1, in the Experimental Examples 1 to 6 of the disclosure, the surface-modified neodymium-iron-boron with good water and gas barrier effects, thin vapor deposition thickness, and low decomposition temperature may be obtained by controlling the proportions of chlorine, fluorine, and alkyl of the oxidation resistant coating materials in the vapor deposition formulation. Specifically, each the surface-modified neodymium-iron-boron alloy material obtained from Experimental Examples 1 to 6 has maximum magnetic energy product greater than 300 kJ/m³ and the thickness of the coating layer below 1.2 μm.

TABLE 2

| | | | | | Maximum |
|---|---|---|---|---|---|
| | | Thickness | | Constant | magnetic |
| | | of the | Decomposition | temperature | energy |
| Comparative | Oxidation resistant | coating | temperature | and humidity | product |
| Example | coating raw material | layer (μm) | (° C.) | test time (hr) | (kJ/m³) |
| 1 | dichloro-p-cyclophane | 0.8 | 300 | 120 | 268 |
| 2 | α-Perfluorodi-p-xylene | 0.2 | 390 | 120 | 296 |
| 3 | α,α′-dimethoxy-p-xylene | 1.1 | 310 | 120 | 274 |

From Table 2, each single-component coating layer product obtained from Comparative Examples 1 to 3 has problem of either excessively high decomposition temperature or low maximum magnetic energy product.

TABLE 3

| | | | | | | Constant | Maximum |
|---|---|---|---|---|---|---|---|
| | Oxidation resistant | | | Thickness | | temperature | magnetic |
| | coating raw material | | | of the | Decomposition | and humidity | energy |
| Comparative | (parts by weight) | | | coating | temperature | test time | product |
| Example | C | AM2 | F | layer (μm) | (° C.) | (hr) | (kJ/m³) |
| 4 | 20 | — | 80 | 0.32 | 370 | 120 | 244 |
| 5 | 50 | — | 50 | 0.5 | 350 | 120 | 288 |
| 6 | 80 | — | 20 | 0.74 | 345 | 120 | 289 |
| 7 | 20 | 80 | — | 1.81 | — | — | — |
| 8 | 50 | 50 | — | 1.52 | — | — | — |
| 9 | 80 | 20 | — | 1.54 | — | — | — |
| 10 | — | 20 | 80 | 0.32 | 370 | 120 | 296 |
| 11 | — | 50 | 50 | 0.53 | 360 | 120 | 301 |
| 12 | — | 80 | 20 | 1.51 | — | — | — |
| 13 | 60 | 20 | 20 | 1.48 | 340 | 120 | 294 |
| 14 | 15 | 5 | 80 | 0.35 | 350 | 120 | 289 |

In Table 3, C represents the Parylene C raw material dichloro-p-cyclophane, AM2 represents the Parylene AM-2 raw material α, α′-dimethoxy-p-xylene, and F represents the Parylene F raw material α-Perfluorodi-p-xylene.

Due to excessively high thickness of coating layer of each product obtained from Comparative Examples 7 to 9 and 12, it is not favorable for subsequent processing and use. Therefore, subsequent measurements of magnetic energy product are not conducted.

From Table 3, the surface-modified NdFEB materials (including the coating layer without the alkyl-substituted parylene) of Comparative Examples 4 to 6 have a problem of low maximum magnetic energy product; the surface-modified NdFeB materials (including the coating layer without the fluorine-substituted parylene) of Comparative Examples 7 to 9 have a problem of too thick thickness of the coating layer; the surface-modified NdFeB materials (including the coating layer without the chloro-substituted parylene) of Comparative Examples 10 and 11 have problems of low maximum magnetic energy product and higher decomposition temperature than others. In addition, the surface-modified NdFEB material (including the coating layer with less fluorine-substituted parylene and without the chloro-substituted parylene) of Comparative Example 12 has a problem of too thick thickness of the coating layer. The surface-modified NdFeB material (including the coating layer with overmuch chloro-substituted parylene) of Comparative Example 13 has problems of too thick thickness of the coating layer and low maximum magnetic energy product. The surface-modified NdFeB material (including the coating layer with less alkyl-substituted parylene) of Comparative Example 14 has a problem of low maximum magnetic energy product.

### Experimental Example 7

The freshly produced NdFeB alloy powders were pressed into a compact with a diameter of 14 mm and a height of 15 mm, and aligned under a maximum magnetic field of 2 Tesla. Subsequently, cold isostatic pressing (CIP) was conducted at a pressure of 300 MPa. The compact was sintered at 1060° C. for 4 hours under a vacuum of 10⁻³ Pa to obtain an NdFeB bulk material as a metallic body.

Then, a coating layer was formed on the surfaces of the NdFeB bulk material by using the coating layer composition and vapor deposition method of Experimental Example 2.

From the aforementioned analysis, the thickness of the coating layer is 0.72 μm and the decomposition temperature is 340° C. After constant temperature and constant humidity test, the maximum magnetic energy product is 338 kJ/m³. Therefore, with the metallic body being NdFeB bulk material, the coating layer may also effectively achieve an oxidation resistant effect.

Although the disclosure has been revealed by the above embodiments, it is not intended to limit the disclosure. Any person skilled in the art may make some modifications and refinements without departing from the spirit and scope of the disclosure. Therefore, the protection scope of the disclosure should be defined by the appended claims.

What is claimed is:

1. An oxidation resistant coating, comprising:
a chloro-substituted parylene; a fluorine-substituted parylene; and an alkyl-substituted parylene, wherein
a weight ratio of chlorine to fluorine to an alkyl group in the oxidation resistant coating is 1-10:6-27:2-15.

2. The oxidation resistant coating according to claim 1, wherein the alkyl group is a C1-C6 straight alkyl or branched alkyl.

3. The oxidation resistant coating according to claim 1, wherein based on 100 parts by weight of a total weight of the oxidation resistant coating, the chloro-substituted parylene is 5 to 40 parts by weight, the fluorine-substituted parylene is 20 to 80 parts by weight, and the alkyl-substituted parylene is 10 to 40 parts by weight.

4. The oxidation resistant coating according to claim 1, wherein the chloro-substituted parylene is 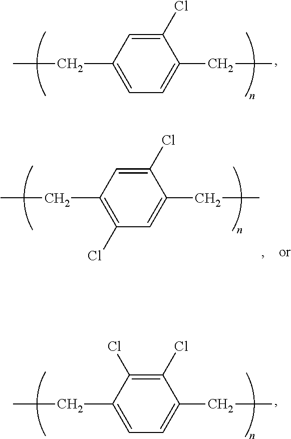
wherein n is an integer between 100 to 10000.

5. The oxidation resistant coating according to claim 1, wherein the fluorine-substituted parylene is 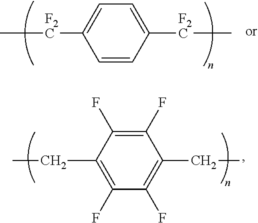
wherein n is an integer between 100 to 10000.

6. The oxidation resistant coating according to claim 1, wherein the alkyl-substituted parylene comprises 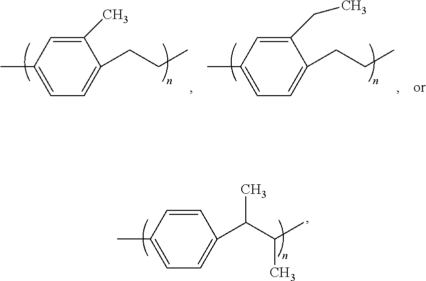
wherein n is an integer between 100 to 10000.

7. The oxidation resistant coating according to claim 1, wherein the weight ratio of the chlorine to the fluorine to the alkyl group in the oxidation resistant coating is 1-8:6-25:2-10.

8. The oxidation resistant coating according to claim 1, wherein the weight ratio of the chlorine to the fluorine to the alkyl group in the oxidation resistant coating is 1-8:8-25:4-10.

9. A surface-modified metal material, comprising:
a metallic body; and
a coating layer, coating on surfaces of the metallic body, wherein the coating layer is the oxidation resistant coating according to claim 1.

10. The surface-modified metal according to claim 9, wherein a material of the metallic body is a metal or alloy containing iron, aluminium, cobalt, nickel, or copper.

11. The surface-modified metal according to claim 10, wherein a material of the metallic body comprises neodymium-iron-boron, aluminium-nickel-cobalt, or samarium-iron-nitrogen.

12. The surface-modified metal material according to claim 9, wherein the metallic body is a powder with a particle size D50 between 1 μm and 80 μm.

13. The surface-modified metal material according to claim 9, wherein a thickness of the coating layer is between 0.2 μm and 1.2 μm.
